(19) United States
(12) Patent Application Publication
(10) Pub. No.: US 2015/0264553 A1
(43) Pub. Date: Sep. 17, 2015

(54) HANDLING OF SIMULTANEOUS CALL SESSION SIDE REGISTRATIONS FOR VOICE OVER LONG TERM EVOLUTION IN A VISITED NETWORK

(71) Applicant: NOKIA SOLUTIONS AND NETWORKS OY, Espoo (FI)

(72) Inventors: Laszlo JANOSI, Budapest (HU); Andras PASZTOR, Budapest (HU); Teuvo Juhani KOPONEN, Coppell, TX (US); Zoltan Janos DUDAR, Roswell, GA (US)

(73) Assignee: NOKIA SOLUTIONS AND NETWORKS OY, Espoo (FI)

(21) Appl. No.: 14/206,563

(22) Filed: Mar. 12, 2014

(51) Int. Cl. H04W 8/06

(52) U.S. Cl. CPC H04W 8/06

(57) ABSTRACT

Various devices may benefit from simultaneous call session side registrations for voice over long term evolution in a visited network. A method can include receiving a request for a roaming number request at a first enhanced network node, wherein the request comprises a first identifier of a user equipment. The method can also include interrogating a first network node to determine address information of a second enhanced network node associated with the user equipment and relaying the request for the roaming number to the second enhanced network node using the address information. The method can also include receiving the request for the roaming number at the second enhanced network node and allocating a roaming number associated with the first identifier of the user equipment. The method can further include returning the roaming number to the first enhanced network node and providing the roaming number to a second network node.

### BACKGROUND

1. Field

Various devices may benefit from simultaneous call session (CS) side registrations for voice over long term evolution (VoLTE) in a visited network. For example, voice centric user equipment (UE) that supports circuit switched fallback (CSFB) and VoLTE may benefit from simultaneous CS side registrations. In particular, UEs as described by the third generation partnership project (3GPP), and UEs' usage in voice and messaging services in 3GPP IP based LTE networks involving IP multimedia subsystem (IMS)/VoLTE, roaming, and 3GPP CS roaming, may benefit from simultaneous CS registrations.

2. Description of the Related Art

Generally, CSFB can include a technology that allows for delivery of voice and short message service (SMS) to LTE devices through the use of global system for mobile communications (GSM) or another circuit-switched network. CSFB may be needed because LTE technology generally supports packet based services only, and cannot support circuit-switched calls. Thus, when an LTE device is used to make or receive a voice call, the device may “fall back” to the 3G or 2G network to complete the call.

When a voice centric UE that supports CSFB and VoLTE roams into an LTE network, it may perform “combined evolved packet system/international mobile subscriber identity (EPS/IMSI) attach”. If the visited network does not support full CSFB and the home network does not support IMS, the UE may reselect a different radio access technology (RAT). This procedure can be performed even if the visited network supports IMS. In this situation the UE may have voice and messaging services through using the IMS/VoLTE network of a visited public land mobile network (VPLMN). Another possible way for the UE to have voice services is to camp on a different VPLMN that supports CSFB (or camp on 2G/3G RAT directly on a different VPLMN). However, that would mean that the original VPLMN (that does not support 2G/3G, for example, a code division multiple access (CDMA) operator) loses the inbound roamers.

Once the issue of attaching the UE to the VPLMN's IMS/VoLTE network is addressed, there may be issues with subscriber data handling and registration at the home location register (HLR). As the subscriber does not have IMS/VoLTE service in the home public land mobile network (HPLMN), there is only the HLR to maintain the subscriber's registration data.

When a UE registers for CSFB via a SGs interface, the HLR in the home network may register a visitor location register (VLR) address for routing the subsequent terminating transactions to a network element (NE) that currently holds the registration (for example, the SGs enhanced mobile switching center (MSC) server). After the location update is performed, an IMS third party registration may occur in this same NE, or to another NE depending on load distribution, via the IP multimedia subsystem service control (ISC) interface. This concurrent registration attempt (existing registration in the SGs enhanced MSC server and new attempt via the ISC interface) may result in a “ping-pong” registration between two physical NEs with two different network addresses. Thus, the NEs could periodically update the HLR with its own address, cancelling the other NE registration, leading to a situation where the SGs registration and services are not available any more.

According to 3GPP 23.221 Annex A, in cases where the VPLMN does not support CSFB or HPLMN does not support IMS, a UE should move to 3G/2G. However, for a carrier without 2G/3G access, that would mean inbound roaming is denied, which could lead to losing revenue.

Thus, it may be desired that the UE could use IMS service in the VPLMN in order to have voice service. In doing so, it may be desired that the VPLMN should obtain subscriber profile and CDRs (for charging purpose) stored in HLR of HPLMN.

### SUMMARY

According to certain embodiments, a method can include receiving a registration request at an enhanced network node via a network interface. The registration request can include a user equipment identifier. The method can also include associating address information of the enhanced network node with the user equipment identifier when the user equipment identifier is stored in a database.

In certain embodiments, a method can include receiving a request for a roaming number request at a first enhanced network node. The request can include a first identifier of a user equipment. The method can also include interrogating a first network node to determine address information of a second enhanced network node associated with the user equipment. The method can further include obtaining the address information responsive to the interrogating. The method can additionally include relaying the request for the roaming number to the second enhanced network node using the address information. The method can also include providing the roaming number to a second network node in response to the request for the roaming number.

A non-transitory computer-readable medium can be, in certain embodiments, encoded with instructions that, when executed in hardware, perform a process that includes either of the above-described methods.

A computer program product can, according to certain embodiments, encode instructions for performing a process that includes either of the above-described methods.

An apparatus, according to certain embodiments, can include at least one processor and at least one memory including computer program code. The at least one memory and the computer program code can be configured to, with the at least one processor, cause the apparatus at least to receive a registration request at an enhanced network node via a network interface. The registration request can include a user equipment identifier. The at least one memory and the computer program code can also be configured to, with the at least one processor, cause the apparatus at least to associate address information of the enhanced network node with the user equipment identifier when the user equipment identifier is stored in a database.

An apparatus, in certain embodiments, can include at least one processor and at least one memory including computer program code. The at least one memory and the computer program code can be configured to, with the at least one processor, cause the apparatus at least to receive a request for a roaming number request at a first enhanced network node, wherein the request includes a first identifier of a user equipment. The at least one memory and the computer program code can also be configured to, with the at least one processor, cause the apparatus at least to interrogate a first network node to determine address information of a second enhanced network node associated with the user equipment. The at least one memory and the computer program code can further be configured to, with the at least one processor, cause the apparatus at least to obtain the address information responsive to the interrogating. The at least one memory and the computer program code can additionally be configured to, with the at least one processor, cause the apparatus at least to relay the request for the roaming number to the second enhanced network node using the address information. The at least one memory and the computer program code can also be configured to, with the at least one processor, cause the apparatus at least to provide the roaming number to a second network node in response to the request for the roaming number.

According to certain embodiments, an apparatus can include means for receiving a registration request at an enhanced network node via a network interface. The registration request can include a user equipment identifier. The apparatus can also include means for associating address information of the enhanced network node with the user equipment identifier when the user equipment identifier is stored in a database.

In certain embodiments, an apparatus can include means for receiving a request for a roaming number request at a first enhanced network node. The request can include a first identifier of a user equipment. The apparatus can also include means for interrogating a first network node to determine address information of a second enhanced network node associated with the user equipment. The apparatus can further include means for obtaining the address information responsive to the interrogating. The apparatus can additionally include means for relaying the request for the roaming number to the second enhanced network node using the address information. The apparatus can also include means for providing the roaming number to a second network node in response to the request for the roaming number.

According to certain embodiments, a method can include receiving a request for a roaming number request at a first enhanced network node. The request can include a first identifier of a user equipment. The method can also include interrogating a first network node to determine address information of a second enhanced network node associated with the user equipment. The method can further include obtaining the address information responsive to the interrogating. The method can additionally include relaying the request for the roaming number to the second enhanced network node using the address information. The method can also include receiving the request for the roaming number at the second enhanced network node. The method can further include allocating a roaming number associated with the first identifier of the user equipment. The method can additionally include returning the roaming number to the first enhanced network node. The method can also include providing the roaming number to a second network node in response to the request for the roaming number.

In certain embodiments, a system can include a first apparatus that includes at least one first processor and at least one first memory including first computer program code. The at least one first memory and the first computer program code can be configured to, with the at least one first processor, cause the first apparatus at least to receive a request for a roaming number request at a first enhanced network node. The request can include a first identifier of a user equipment. The at least one first memory and the first computer program code can also be configured to, with the at least one first processor, cause the first apparatus at least to interrogate a first network node to determine address information of a second enhanced network node associated with the user equipment. The at least one first memory and the first computer program code can further be configured to, with the at least one first processor, cause the first apparatus at least to obtain the address information responsive to the interrogating. The at least one first memory and the first computer program code can additionally be configured to, with the at least one first processor, cause the first apparatus at least to relay the request for the roaming number to the second enhanced network node using the address information. The system can also include a second apparatus that includes at least one second processor and at least one second memory including second computer program code. The at least one second memory and the second computer program code can be configured to, with the at least one second processor, cause the second apparatus at least to receive the request for the roaming number at the second enhanced network node. The at least one second memory and the second computer program code can also be configured to, with the at least one second processor, cause the second apparatus at least to allocate a roaming number associated with the first identifier of the user equipment. The at least one second memory and the second computer program code can additionally be configured to, with the at least one second processor, cause the second apparatus at least to return the roaming number to the first enhanced network node. The at least one first memory and the first computer program code can further be configured to, with the at least one first processor, cause the first apparatus at least to provide the roaming number to a second network node in response to the request for the roaming number.

### BRIEF DESCRIPTION OF THE DRAWINGS

For proper understanding of the invention, reference should be made to the accompanying drawings, wherein:

FIG. 1 illustrates a network architecture according to certain embodiments.

FIG. 2 illustrates a signaling flow according to certain embodiments.

FIG. 3 illustrates a signaling flow according to certain embodiments pertaining to mobile terminated calls.

FIG. 4 illustrates a method according to certain embodiments.

FIG. 5 illustrates another method according to certain embodiments.

FIG. 6 illustrates another method according to certain embodiments.

FIG. 7 illustrates yet another method according to certain embodiments.

FIG. 8 illustrates UE behavior according to certain embodiments.

FIG. 9 illustrates a system according to certain embodiments.

### DETAILED DESCRIPTION

Certain embodiments may provide, among other things, various ways to address simultaneous CS side registrations for VoLTE in the visited network. In particular, in certain embodiments, CS HLR registration for a subscriber from two VLRs may be managed via the SGs and ISC network interfaces in the visited LTE network using at least one or more Intelligent Roaming Interworking Functions (IRIF). The IRIF may include a SGs enhanced mobile switching center server (MSS)/VLR and media gateway (MGW) plus multi-media telecommunications (MMTEL) telecom application server (TAS)/media resource function (MRF) functions. The IRIF may resolve terminating session routing in a case of multiple VLRs.

For example, in certain embodiments, use of the above mechanism may occur when the UE has both CSFB and IMS/VoLTE clients, and the operator wants to offer VoLTE service in the visited LTE network. In such situation, the visited network operator that already supports IMS/VoLTE, can support inbound roamers by implementing the IRIF. The home network operator of the subscriber does not need to support IMS based VoLTE core.

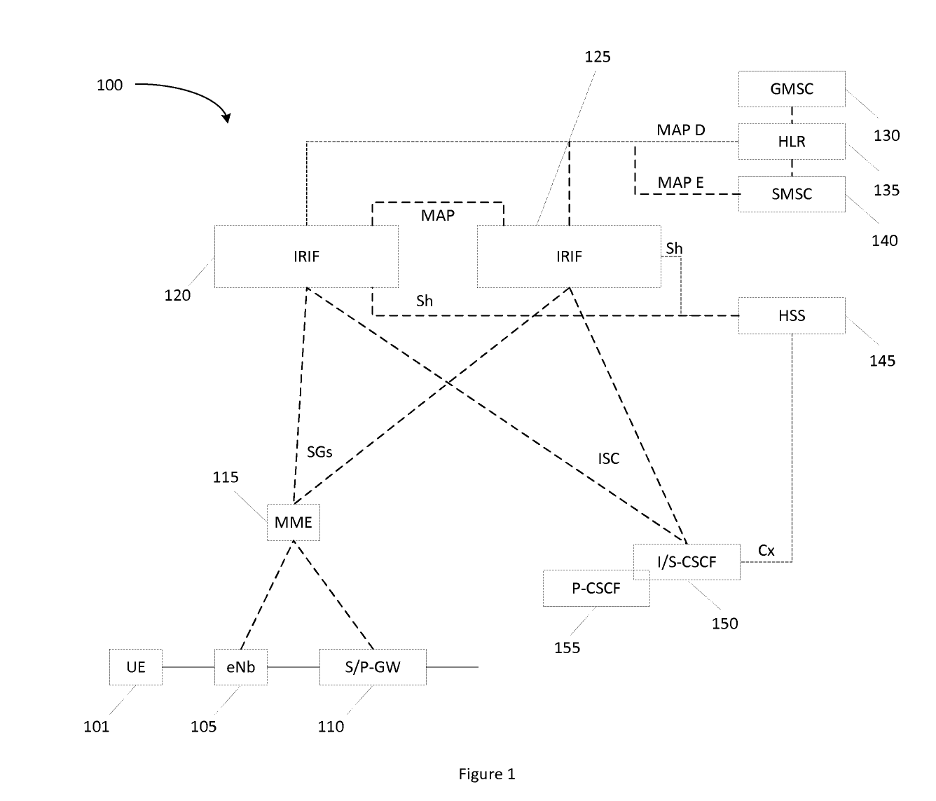

FIG. 1 illustrates a network architecture 100 according to certain embodiments. This network architecture 100 may include a UE 101 connected to an evolved node B (eNb) 105. The eNb 105 may be connected to an access gateway platform (S/P-GW) 110. The eNb 105 and S/P-GW 110 may be connected to a mobility management entity (MME) 115 that further directs the UE 101 to the IRIFs 120, 125 via a SGs network interface. The IRIFs 120, 125 may in turn be connected to an HLR 135, which may be connected to a gateway mobile switching center (GMSC) 130, and a short message service center (SMSC) 140 via a mobile application part (MAP) D and MAP E, respectively. The network architecture 100 may also include an I/S-call session control function (I/S-CSCF) 150 and a proxy-call session control function (P-CSCF). The I/S-CSCF 150 may be connected to the IRIFs 120, 125 via an ISC network interface and to a home subscriber server (HSS) 145 via a Cx network interface. Further, the HSS 145 may also be connected to the IRIFs 120, 125 via Sh network interfaces. Additionally, the IRIFs 120, 125 may be connected to each other and communicate with each other via a MAP network interface.

EPS attach may include “Combined EPS/IMSI attach” over SGs to IRIF serving SGs, and location update to the HLR. Normal IMS third party registration to the IRIF application may occur over ISC. As the VPLMN IMS does not have any information about the subscriber with the standard IMS functionality, this third party registration can be triggered based on pre-defined subscriber profile information in the IMS.

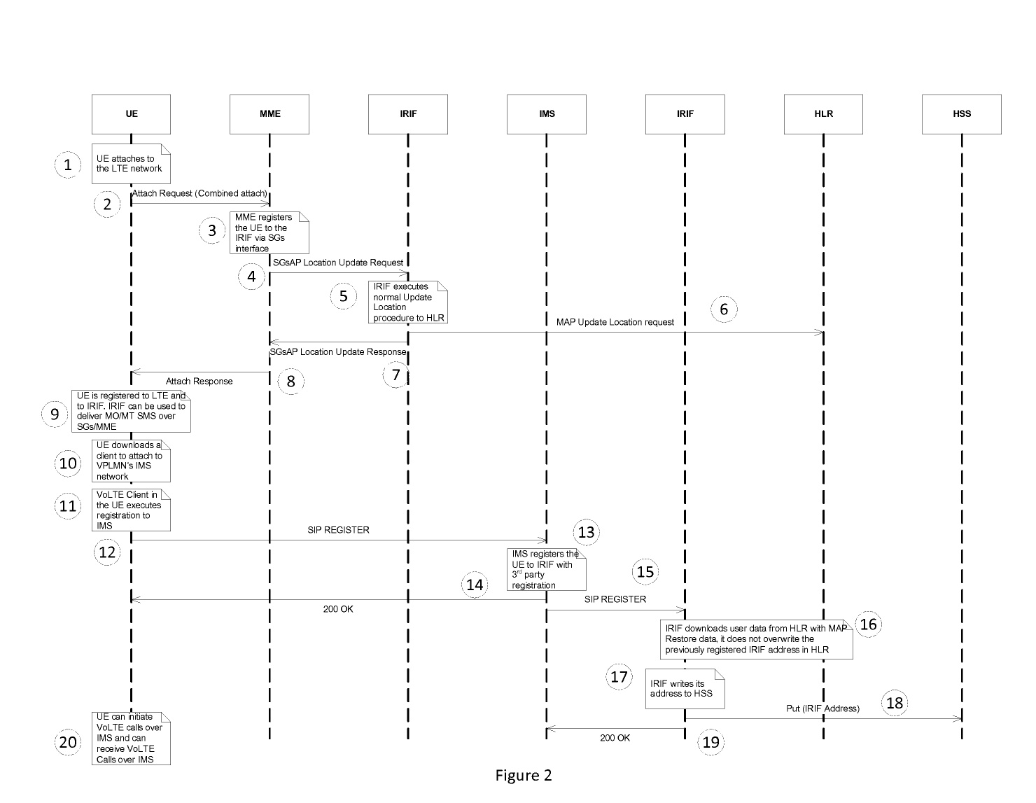

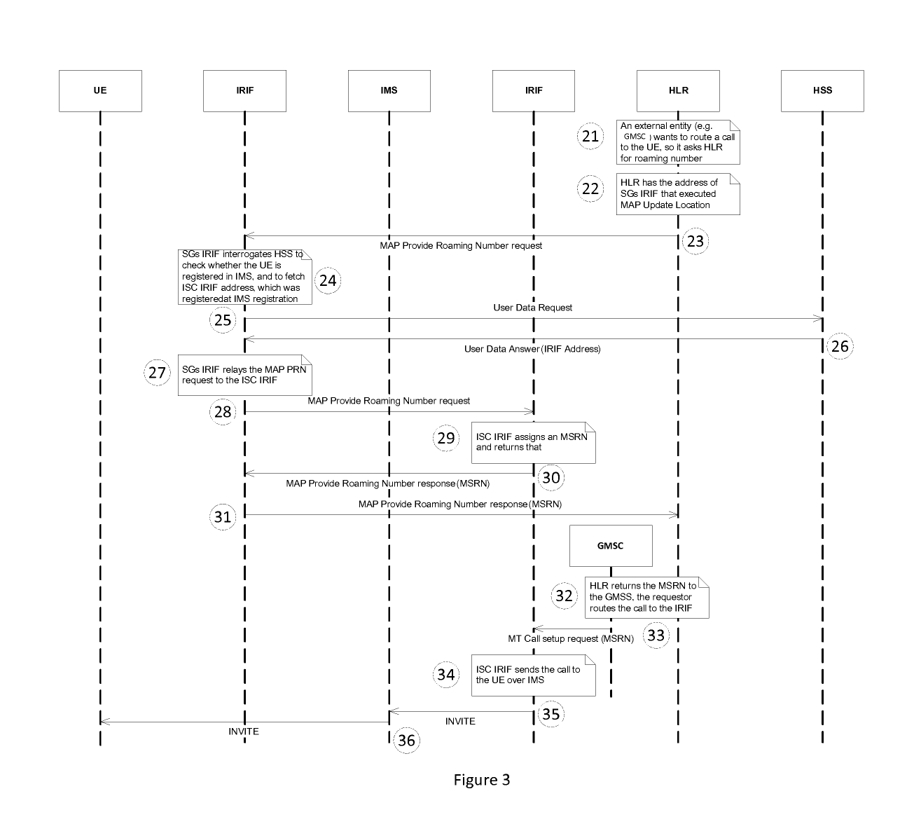

In order to manage HLR registration in certain embodiments, and avoid dual registration and VLR “ping-pong” effect, the IRIF serving the ISC registration may function in multiple ways. For example, in certain embodiments, if user data does not exist in the VLR, the IRIF may fetch data from the HLR using MAP restore data procedure. Such an application may occur when different IRIFs are serving SGs and ISC, as shown in FIGS. 2 and 3. In contrast, if user data already exists in the VLR, no MAP restore data procedure is performed. Such an application may occur when the same IRIF is serving both the SGs and ISC. This procedure optimizes the signaling need and provides flexibility to have multiple IRIFs freely deployed in the network (for example, in a geo-redundant configuration). The IRIF serving the ISC registration stores its own address to the local (home subscriber server) HSS (for example, IMSI based data). This data may be used for resolving a mobile terminated call.

FIG. 2 illustrates a signaling flow according to certain embodiments. FIG. 2 more particularly illustrates an exemplary signaling flow for simultaneous CS side registrations for VoLTE in a visited network.

At 1, the UE may attach to the LTE network. This may be accomplished by sending an attach request at 2, which may be a “Combined EPS/IMSI attach”. At 3, the MME may register the UE to a first IRIF (SGs IRIF) via the SGs network interface in response to the attach request. Such registration may correspond to a registration for CSFB. Upon registration, the MME, at 4, may send a SGsAP location update request to the SGs IRIF, where at 5, the SGs IRIF associated with the SGs network may execute normal update location procedures to the HLR in response to the location update request. This may be accomplished at 6, where the SGs IRIF sends a MAP update location request to the HLR.

At 7, the SGs IRIF may send a SGsAP location update response to the MME, which at 8, attaches the response and sends the response to the UE. At 9, as a result of receiving the attached response, the UE is registered to the LTE network and to the SGs IRIF. In certain embodiments, the SGs IRIF can be used to deliver MO/MT SMS over the SGs/MME. At 10, the UE may download a client to attach to the VPLMN's IMS network. Upon download the client, the VoLTE client in the UE may execute registration to the IMS by sending, at 12 a session initiation protocol (SIP) request to the IMS. The IMS can then, at 13, register the UE to a second IRIF (ISC IRIF) with a third party registration. This registration to the ISC IRIF may be performed over the ISC network interface. Then, at 14 and 15, the IMS may send an authorization response to the UE and SIP register to the ISC IRIF, respectively. In response to the SIP register, the ISC IRIF may download user data from the HLR with MAP restore data. In certain embodiments, the address information of the ISC IRIF does not overwrite any previously registered address in the HLR.

At 17, the ISC IRIF writes its address to the HSS, which is accomplished at 18 where the ISC IRIF serving the ISC registration may store its own address to the local HSS. This data may be used for resolving a mobile terminated call. An acknowledgement is sent from the second IRIF to the IMS, at 19, which then allows the UE to initiate VoLTE calls over the IMS, and receive VoLTE calls over IMS, at 20.

FIG. 2 illustrates two different IRIF functionalities. First, on one side, IRIF functions as a SGs server (SGs MSC Server), and it may handle SGs interface related procedures and fetch subscriber data with normal update location procedure from the HLR. Second, on the other side, the IRIF executes IMS application server functionalities. The two functions of IRIF can reside in the same physical network element, or can be in different physical network elements. The selection of the physical network element for SGs server purposes and for IMS AS purposes determines whether they are in the same physical network element or not. In certain embodiments, the SGs server may be selected by the MME at LTE registration with its own logic, and IMS AS may be selected by S-CSCF at the IMS registration with its own logic. The two selections may overlap in the decision, or they may not.

If the two IRIF functions are in the same physical network element, MAP restore data may not be executed at the IMS registration time, because the subscriber data is already available in the physical network element, as LTE registration was already executed at that time, so SGs Server functionality of IRIF already downloaded the subscriber data from HPLMN HLR with MAP location update procedure.

FIG. 3 illustrates a signaling flow according to certain embodiments pertaining to mobile terminated (MT) calls. When a roaming number request (MAP PRN) arrives for a subscriber, it may be received by the IRIF serving the SGs registration. For example, in certain embodiments, at 21, the HLR may detect an external entity (for example, gateway mobile switching center (GMSC)) that may want to route a call to the UE. To do so, the external entity may ask the HLR for a roaming number.

At 22, the HLR, may have the address of the SGs IRIF that executed the MAP update location request. Thus, at 23, the HLR may send a MAP provide roaming number (PRN) request to the SGs IRIF. In these illustrations of certain embodiments, a MAP PRN request can be one example of a request for a roaming number. In response to the receipt of the MAP PRN request, the SGs IRIF may, at 24, interrogate the HSS to check whether the UE is registered in the IMS, and to fetch the address of the ISC IRIF associated with the ISC, which was registered at the IMS registration described above with regard to FIG. 2. At 25, the SGs IRIF may send a user data request to the HSS, upon which the HSS at 26, may send a user data answer with the ISC IRIF address to the SGs IRIF. At 27, the SGs IRIF may relay the MAP PRN request to the ISC IRIF based on the user data answer, and at 28, may send the MAP PRN request to the ISC IRIF.

At 29, the ISC IRIF may assign or allocate a mobile station roaming number (MSRN) and return a MAP PRN response, including the MSRN, to the SGs IRIF at 30. At 31, in reply to the MAP PRN response, the SGs IRIF may provide the MAP PRN response, including the MSRN, to the HLR. At 32, the HLR may return the MAP PRN number response to the GMSC, and the requestor may route the call to the IRIF. For example, in certain embodiments, at 33, the GMSC may send the MT call setup request to the ISC IRIF. At 34, the ISC IRIF may send the call to the UE over IMS. In particular, the ISC IRIF may at 35, send an invite to the IMS, which at 36, may forward the invite to the UE.

Since the ISC registration of the subscriber may be in a different IRIF element, the IRIF with SGs registration needs to resolve the correct network element by fetching the IRIF address (serving ISC interface) from the HSS (for example, using IMSI). After resolving the IRIF address serving the ISC, the IRIF (SGs IRIF) relays the PRN to the new IRIF (ISC IRIF). The new IRIF may reserve the roaming number for the call and provides it to HLR. The MT call may arrive from the home network GMSC to the IRIF serving the ISC. The IRIF may then anchor the call, execute terminating services for the user, and break into the IMS via ISC interface. The IMS call may then be delivered normally to the user. The same sequence may be executed even if the two IRIF functions are in the same physical network element.

In mobile originated (MO) calls, the MO call may be executed normally per 3GPP IMS/GSMA IR.92 specifications. TAS/MRF function in ISC IRIF may provide the originating services. Originating services of the subscriber were downloaded from HPLMN HLR at registration time. The only change may be that the IMS is in the VPLMN, not in the HPLMN. For MO/MT SMS delivered over SGs and MAP interfaces per 3GPP 23.272 via the IRIF serving the SGs registration, there is no new functionality in it.

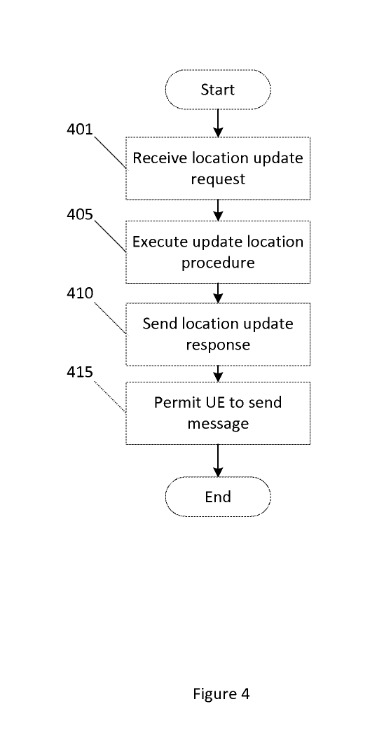

FIG. 4 illustrates a method according to certain embodiments. FIG. 4 more specifically illustrates a registration process between a SGs IRIF and an LTE network, according to certain embodiments. The method of FIG. 4 may be performed by, for example, a SGs IRIF. As shown in FIG. 4, the method may include, at 401, receiving a location update request at the SGs IRIF from the MME via a SGs interface. The method may further include, at 405, executing an update location procedure to the HLR based on the location update request from the MME. This may be accomplished by, for example, sending a MAP update location request to the HLR. In certain embodiments, the update location request sent to the HLR may include address information of the SGs IRIF. The method may also include, at step 410, sending a location update response from the SGs IRIF based on the update location procedure to the MME via the SGs network interface. The method may further include, at 415, permitting a UE to send a message over the SGs network interface and via the MME based on the update location procedure when the UE is registered an LTE network.

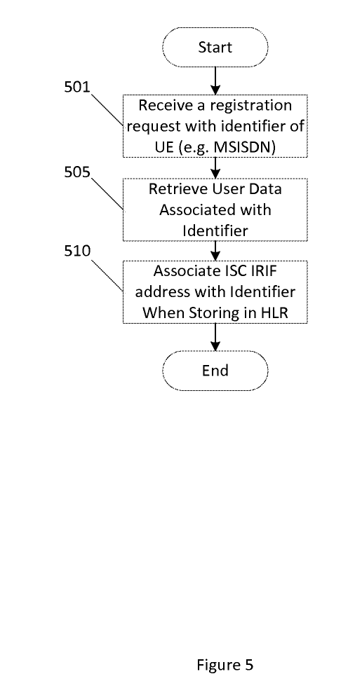

FIG. 5 illustrates another method according to certain embodiments. FIG. 5 more specifically illustrates a registration process between an ISC IRIF and an LTE network, according to certain embodiments. The method of FIG. 5 may be performed by, for example, an ISC IRIF. As shown in FIG. 5, the method may include, at 501, receiving a registration request, such as, for example, a SIP register, at the ISC IRIF from the IMS. The registration request can include an identifier of the UE, such as a mobile station international subscriber directory number (MSISDN). Other UE identifiers are also possible. This registration request may be sent via the ISC network interface. The method may also include the ISC IRIF, at 505, retrieving user data associated with the identifier, from the HLR. The method may further include, at 510 associating address information of the ISC IRIF with the identifier when the identifier is stored in the HLR. In certain embodiments, the address information of the ISC IRIF does not overwrite any previously registered address stored in the HLR. The method may permit a UE to initiate and receive VoLTE calls over the IMS.

In certain embodiments and illustrates the two IRIFs are shown separate. However, the two IRIFs could be co-located in one physical network element. In this case, the two IRIFs can share the same database, such as the HLR. So, when the ISC IRIF starts the registration, the ISC IRIF can recognize that the UE has already registered in the database. Step 505 may not be needed in this case. However, the rest of the procedure remains the same.

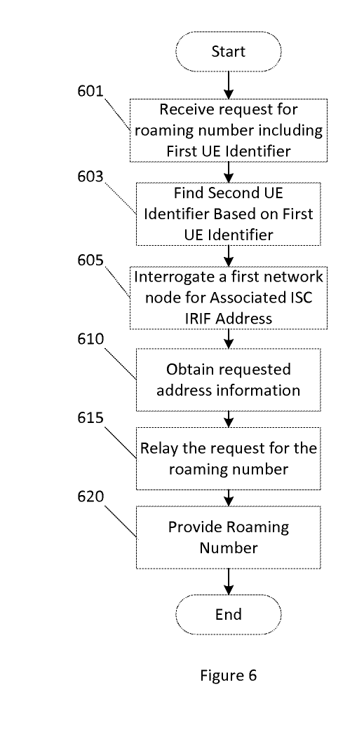

FIG. 6 illustrates another method according to certain embodiments. FIG. 6 more specifically illustrates a process of resolving the correct network element by fetching the ISC IRIF address from the HSS. The method of FIG. 6 may be performed by, for example, a SGs IRIF. As shown in FIG. 6, the method may include, at 601, receiving a request for a roaming number, such as a MAP PRN request, from the HLR in response to the HLR receiving a request, from an external entity, to route a call to a UE. The request may include an identifier of the UE, such as an IMSI. Other UE identifiers are permitted. The UE identifier may correspond to the UE at which the call is supposed to be terminated.

The method may also include, at 603, the SGs IRIF finding a UE identifier, such as the MSISDN, of the subscriber in the SGs IRIF's own local database, based on the received IMSI. Thus, a first user equipment identifier, such as the IMSI, may be used to look up a second user equipment identifier, such as an MSISDN.

The method may also include, at 605, interrogating the HSS by the SGs IRIF to fetch the ISC IRIF address stored in the HSS, which was registered at the IMS registration previously discussed, and consequently is associated with the UE identifier, such as the MSISDN. The method may further include, at 610, obtaining address information of the ISC IRIF in response to the interrogating.

The method may also include, at 615, relaying the request for the roaming number to the ISC IRIF in response to obtaining the address information. The method may further include, at 620, providing the roaming number, for example by sending a MAP PRN response to the HLR, which can later be used to route the incoming call to the UE.

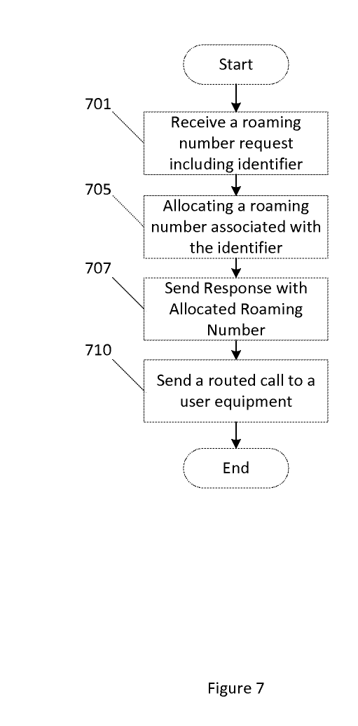

FIG. 7 illustrates another method according to certain embodiments. FIG. 7 more specifically illustrates a process of routing a call from an external entity to the UE. The method of FIG. 7 may be performed by, for example, an ISC IRIF. As shown in FIG. 7, the method may include, at 701, receiving a request for roaming number, e.g. MAP PRN request, from the SGs IRIF. The request may comprise an identifier (e.g. IMSI) of a UE at which a call is supposed to be terminated. The method may also include, at 705, allocating a roaming number associated with the identifier of the UE and, at 707, sending a response (e.g. MAP PRN response) comprising the allocated roaming number to the SGs IRIF. As a result, the SGs IRIF may reserve the roaming number for the call and provide it to the HLR as described in FIG. 6. The ISC IRIF may then anchor the call, execute terminating services for the user, and break into the IMS via the ISC interface. Thus, as shown in the method of FIG. 7, at 710, the ISC IRIF may send the routed call to the UE over the IMS via the ISC network interface.

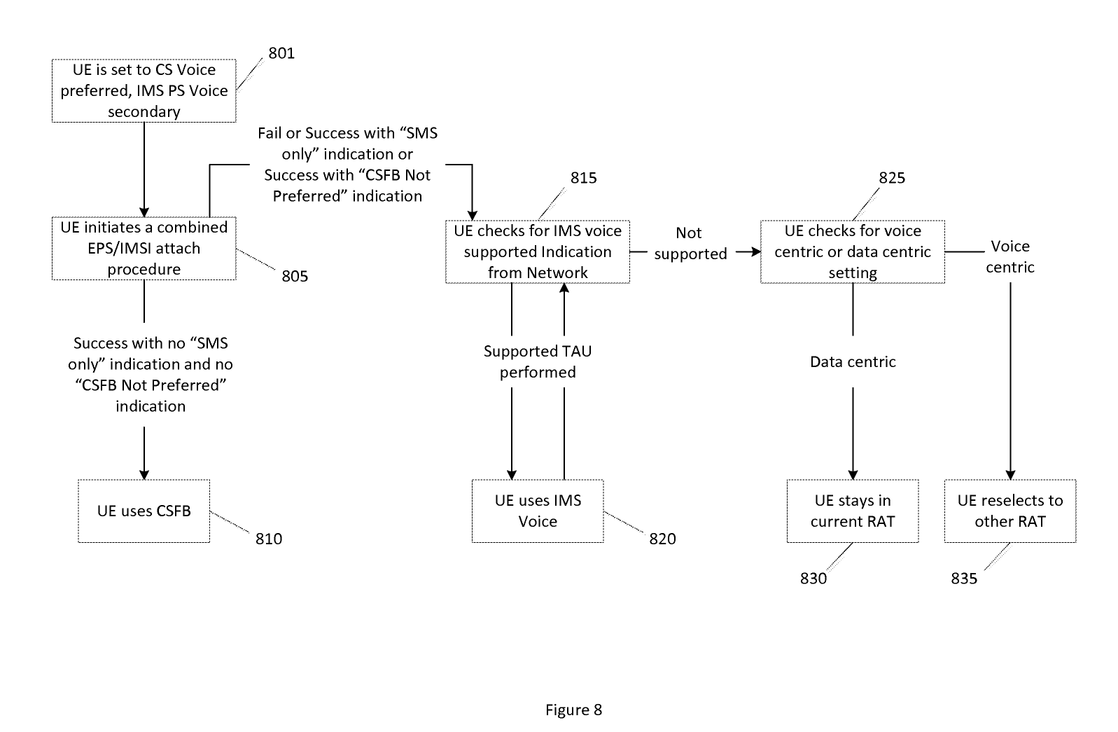

FIG. 8 illustrates UE behavior according to certain embodiments. For example, the UE supporting both CSFB and IMS Packet Switched (PS) Voice logic is illustrated in FIG. 8. The UE logic can be used in the context of certain embodiments of the network invention. At 801, the UE may be set to a CS Voice preferred, IMS PS Voice secondary. At 805, the UE may initiate a combined EPS/IMSI attach procedure. If there is success with no “SMS only” indication and no “CSFB Not Preferred” indication, the UE may then, at 810, use CSFB. However, if there is failure or success with “SMS only” indication or success with “CSFB Not Preferred” indication, then the UE, at 815, may check for IMS voice supported indication from the network. If supported, at 820, the UE may use IMS voice, and tracking area update (TAU) procedures may be performed.

If there is no support indication from the network, then, at 815, the UE may check for voice centric or data centric settings. If the setting is data centric, then, at 830, the UE may stay in the current RAT. However, if the setting is voice centric, then, at 835, the UE may reselect to another RAT.

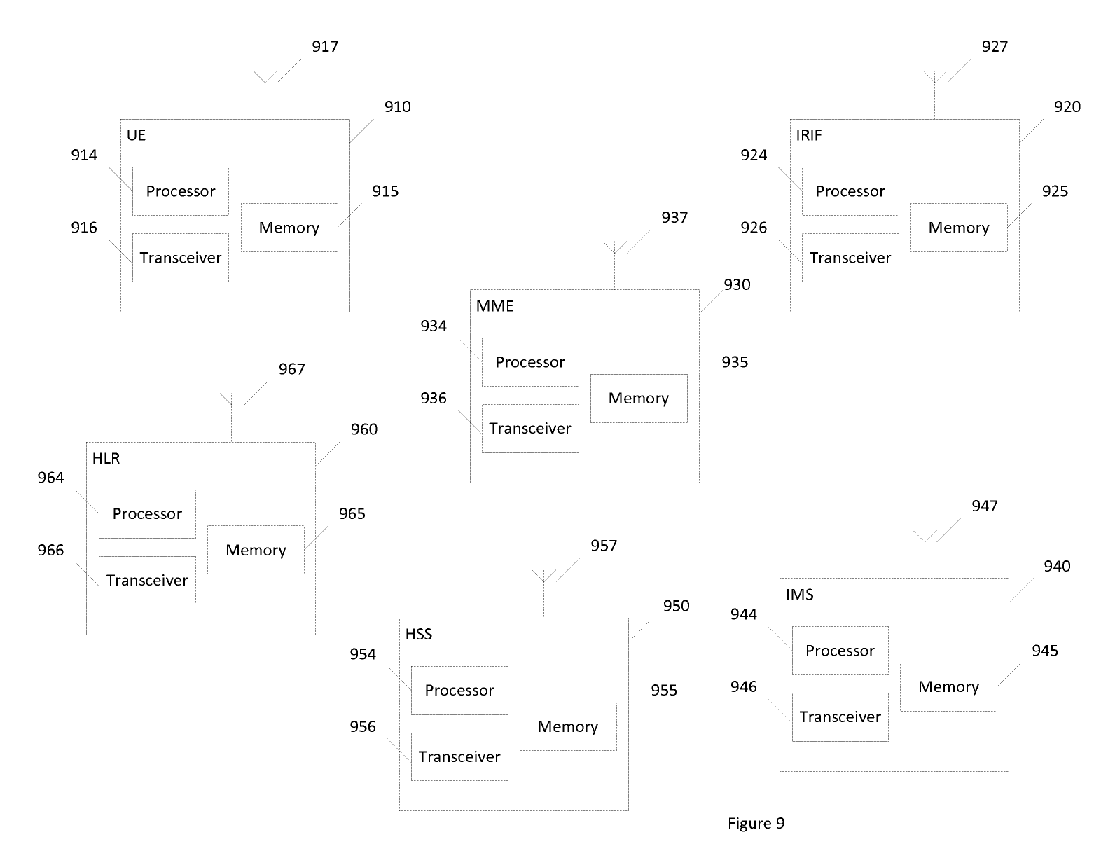

FIG. 9 illustrates a system according to certain embodiments of the present invention. In one embodiment, a system may include multiple devices, such as, for example, at least one UE 910, at least one IRIF 920, at least one MME 930, at least one IMS 940, at least one HSS 950, and at least one HLR 960. In certain systems, UE 910, IRIF 920, MME 930, IMS 940, HSS 950, and HLR 960 may be present. Other configurations are also possible.

The UE 910 can be any terminal device, such as a cell phone, a smart phone, a personal digital assistant, a tabletop computer, a personal computer, a laptop computer, a mini-tablet computer, a tablet computer, or the like.

Each of these devices may include at least one processor, respectively indicated as 914, 924, 934, 944, 954, and 964. At least one memory may be provided in each device, as indicated at 915, 925, 935, 945, 955, and 965, respectively. The memory may include computer program instructions or computer code contained therein. The processors 914, 924, 934, 944, 954, and 964 and memories 915, 925, 935, 945, 955, and 965, or a subset thereof, can be configured to provide means corresponding to the various blocks of FIGS. 4-7. Although not shown, the UE may also include positioning hardware, such as a global positioning system (GPS) or micro electrical mechanical system (MEMS) hardware, which can be used to determine a location of the device. Other sensors are also permitted and can be included to determine location, elevation, orientation, and so forth, such as barometers, compasses, and the like.

As shown in FIG. 9, transceivers 916, 926, 936, 946, 956, and 966 may be provided, and each device may also include at least one antenna, respectively illustrated as 917, 927, 937, 947, 957, and 967. The devices may have many antennas, such as an array of antennas configured for multiple input multiple out (MIMO) communications, or multiple antennas for multiple radio access technologies. Other configurations of these devices, for example, may be provided. For example, UE 910 may additionally be configured for wired communication, and in such a case, antenna 917 would also illustrate any form of communication hardware, without requiring a conventional antenna.

Transceivers 916, 926, 936, 946, 956, and 966 may each, independently, act and/or function as a transmitter, receiver, or both a transmitter and a receiver, or a unit or device that is configured both for transmission and reception.

Processors 914, 924, 934, 944, 954, and 964 may be embodied by any computational or data processing device, such as a central processing unit (CPU), application specific integrated circuit (ASIC), or comparable device. The processors 914, 924, 934, 944, 954, and 964 can be implemented as a single controller, or a plurality of controllers or processors according to other embodiments. The processors 914, 924, 934, 944, 954, and 964 can be any type of general or specific-purpose processor. Processors 914, 924, 934, 944, 954, and 964 may also include one or more of general-purpose computers, special-purpose computers, microprocessors, digital signal processors (DSPs), field-programmable gate arrays (FPGAs), ASICs, and/or processors based on a multi-core processor architecture, as examples.

Memories 915, 925, 935, 945, 955, and 965 may independently be any suitable storage device, such as a non-transitory computer-readable medium. The memories 915, 925, 935, 945, 955, and 965 may include computer program instructions or computer code. The memories 915, 925, 935, 945, 955, and 965 can be one or more memories of any type suitable to the local application environment, and can be implemented using any suitable volatile or nonvolatile data storage technology such as semiconductor-based memory device, a magnetic memory device and system, an optical memory device and system, fixed memory, and removable memory. For example, memories 915, 925, 935, 945, 955, and 965 may include any combination of random access memory (RAM), read only memory (ROM), flash memory, static storage such as magnetic or optical disk, hard disk drive (HDD), or any other type of non-transitory machine or computer readable media. The instructions stored in memories 915, 925, 935, 945, 955, and 965 may include program instructions or computer program code that, when executed by processors 914, 924, 934, 944, 954, and 964, enable the devices to perform tasks as described herein. Alternatively, certain embodiments may be performed entirely in hardware. Furthermore, the computer program instructions stored in the memory and which may be processed by the processors can be any suitable form of computer program code, for example, a compiled or interpreted computer program written in any suitable programming language.

Additionally, although FIG. 9 illustrates a system including a UE 910, IRIF 920, MME 930, IMS 940, HSS 950, and HLR 960, embodiments of the invention may be applicable to other configurations, and configurations involving additional elements.

Certain embodiments of the present invention may achieve distinct advantages. For example, the CS home network (HPLMN) operator does not need to invest in additional IMS infrastructure. Further, the HPLMN operator can extend the life of its existing CS network. Additionally, the HPLMN operator can rely on existing CS technology based roaming agreements to provide IP roaming coverage to its users.

In other embodiments, the PS visited network (VPLMN) operator also provides distinct advantages. For example, the VPLMN operator does not need to invest in 2G and 3G radio and core network to provide inbound roaming services to CS operator subscribers. The VPLMN operator can also leverage IMS infrastructure and Mobile broadband radio technologies to provide ‘inbound’ roaming services to CS operator subscribers. Further, the VPLMN operator can rely on existing CS technology based roaming agreements to provide IP roaming coverage to CS users

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims

Glossary

| | |
|---|---|
| ASIC | Application Specific Integrated Circuit |
| CDR | Call Data Record |
| CPU | Central Processing Unit |
| CS | Call Session |
| CSFB | Circuit Switched Fallback |
| DSP | Digital Signal Processors |
| EPS | Evolved Packet System |
| FPGA | Field-Programmable Gate Arrays |
| GMSC | Global Mobile Switching Center |
| GPS | Global Positioning System |
| GSM | Global System for Mobile Communications |
| HDD | Hard Disk Drive |
| HLR | Home Location Resource |
| HPLMN | Home Public Land Mobile Network |
| HSS | Home Subscriber Server |
| IMSI | International Mobile Subscriber Identity |
| ISC | IP Multimedia Subsystem Service Control Interface |
| MAP | Mobile Application Part |
| MAP PRN | Mobile Application Part Provide Roaming Number |
| MIMO | Multiple Input Multiple Output |
| MME | Mobile Management Entity |
| MMTEL | Mobile Telephony |
| MRF | Media Resource Function |
| MSC | Mobile Switching Center |
| MSISDN | Mobile Station International Subscriber Directory number |
| MSRN | Mobile Station Roaming Number |
| MSS | Mobile Switching Center Server |
| PRN | Provide Roaming Number |
| RAM | Random Access Memory |
| RAT | Radio Access Technology |
| ROM | Read Only Memory |
| SIP | Session Initiation Protocol |
| SMS-MT | Short Message Mobile Terminated Point-to-Point |
| TAS | Telecom Application Server |
| TAU | Tracking Area Update |
| VLR | Visitor Location Register |
| VPLMN | Visited Public Land Mobile Network |
| VoLTE | Voice Over Long Term Evolution |

We claim:

1. A method, comprising:
receiving a registration request at an enhanced network node via a network interface, wherein the registration request comprises a user equipment identifier; and
associating address information of the enhanced network node with the user equipment identifier when the user equipment identifier is stored in a database.

2. The method of claim 1, further comprising:
retrieving, by the enhanced network node, user data associated with the identifier from a second network node, wherein the associating is based on the user data.

3. The method of claim 2, wherein the address information of the enhanced network node does not overwrite any previously registered address in the second network node.

4. The method of claim 1, wherein the network interface comprises an ISC interface.

5. A method, comprising:
receiving a request for a roaming number request at a first enhanced network node, wherein the request comprises a first identifier of a user equipment;
interrogating a first network node to determine address information of a second enhanced network node associated with the user equipment;
obtaining the address information responsive to the interrogating;
relaying the request for the roaming number to the second enhanced network node using the address information; and
providing the roaming number to a second network node in response to the request for the roaming number.

6. The method of claim 5, further comprising:
finding a second identifier of the user equipment in a local database, based on the first identifier; and
using the second identifier when interrogating the first network node for the address information.

7. An apparatus, comprising:
at least one processor; and
at least one memory including computer program code,
wherein the at least one memory and the computer program code are configured to, with the at least one processor, cause the apparatus at least to
receive a registration request at an enhanced network node via a network interface, wherein the registration request comprises a user equipment identifier; and
associate address information of the enhanced network node with the user equipment identifier when the user equipment identifier is stored in a database.

8. The apparatus of claim 7, wherein the at least one memory and the computer program code are further configured to, with the at least one processor, cause the apparatus at least to:
retrieve user data associated with the identifier from a second network node, wherein the associating is based on the user data.

9. The apparatus of claim 8, wherein the address information of the enhanced network node does not overwrite any previously registered address in the second network node.

10. The apparatus of claim 8, wherein the second network node comprises a home location register or a home subscriber server.

11. The apparatus of claim 7, wherein the network interface comprises an ISC interface.

12. The apparatus of claim 7, wherein the enhanced network node comprises an intelligent roaming interworking function.

13. The apparatus of claim 7, wherein the database comprises a home location register or a home subscriber server.

14. An apparatus, comprising:
at least one processor; and
at least one memory including computer program code,
wherein the at least one memory and the computer program code are configured to, with the at least one processor, cause the apparatus at least to
receive a request for a roaming number request at a first enhanced network node, wherein the request comprises a first identifier of a user equipment;
interrogate a first network node to determine address information of a second enhanced network node associated with the user equipment;
obtain the address information responsive to the interrogating;
relay the request for the roaming number to the second enhanced network node using the address information; and
provide the roaming number to a second network node in response to the request for the roaming number.

15. The apparatus of claim 14, wherein the at least one memory and the computer program code are further configured to, with the at least one processor, cause the apparatus at least to:
find a second identifier of the user equipment in a local database, based on the first identifier; and
use the second identifier when interrogating the first network node for the address information.

16. The apparatus of claim 14, wherein the first enhanced network node comprises an intelligent roaming interworking function.

17. The apparatus of claim 14, wherein the second enhanced network node comprises an intelligent roaming interworking function.

18. The apparatus of claim 15, wherein the first network node comprises a home location register or a home subscriber server.

19. A method, comprising:
receiving a request for a roaming number request at a first enhanced network node, wherein the request comprises a first identifier of a user equipment;
interrogating a first network node to determine address information of a second enhanced network node associated with the user equipment;
obtaining the address information responsive to the interrogating;
relaying the request for the roaming number to the second enhanced network node using the address information;
receiving the request for the roaming number at the second enhanced network node;
allocating a roaming number associated with the first identifier of the user equipment;
returning the roaming number to the first enhanced network node; and
providing the roaming number to a second network node in response to the request for the roaming number.

20. A system, comprising:
a first apparatus comprising at least one first processor and at least one first memory including first computer program code, wherein the at least one first memory and the first computer program code are configured to, with the at least one first processor, cause the first apparatus at least to
receive a request for a roaming number request at a first enhanced network node, wherein the request comprises a first identifier of a user equipment,
interrogate a first network node to determine address information of a second enhanced network node associated with the user equipment,
obtain the address information responsive to the interrogating, and
relay the request for the roaming number to the second enhanced network node using the address information; and
a second apparatus comprising at least one second processor and at least one second memory including second computer program code, wherein the at least one second memory and the second computer program code are configured to, with the at least one second processor, cause the second apparatus at least to
receive the request for the roaming number at the second enhanced network node,
allocate a roaming number associated with the first identifier of the user equipment, and
return the roaming number to the first enhanced network node, wherein the at least one first memory and the first computer program code are further configured to, with the at least one first processor, cause the first apparatus at least to provide the roaming number to a second network node in response to the request for the roaming number.
